(19) United States
(12) Patent Application Publication
(10) Pub. No.: US 2004/0149112 A1
(43) Pub. Date: Aug. 5, 2004

(54) Cutting guide

(76) Inventor: Joseph John Snell, Oatlands (AU)

Correspondence Address: John F Hoffman, Baker & Daniels, Suite 800, 111 East Wayne Street, Fort Wayne, IN, 46802, US

(21) Appl. No.: 10/474,626

(22) PCT Filed: Apr. 9, 2002
(86) PCT No.: PCT/AU02/00452

(30) Foreign Application Priority Data
Apr. 11, 2001 (AU) PR 4380
May 7, 2001 (AU) PR 4835

(51) Int. Cl. B27B 21/00

(52) U.S. Cl. 83/745; 83/821

(57) ABSTRACT

A cutting guide for cutting dovetail and other joints has a guide for the receipt of a saw blade. This guide is in the form of opposed guide plates (71, 72) or a single guide plate (271). Each guide plate (71, 72, 271) is pivotally mounted to a shaft (51, 52, 251) and can be fixed at any given angle on the shaft (51, 52, 251). Each shaft (51, 52, 251) is rotatable, and the shafts are on a mounting (22, 222) which receives the work-piece.

### TECHNICAL FIELD

The present invention relates primarily to apparatus that can be used as an aid in making accurate saw cuts. Various preferred embodiments of the invention are particularly suitable for cutting timber and the like for dovetail and other joints. Other preferred embodiments of the invention are particularly suitable in orthopaedic surgery.

### BACKGROUND ART

Jigs for cutting dovetail joints are known. (Throughout this specification, the term ‘dovetail joint’ is used to denote what are also known as ‘through dovetail joints’, as distinct from ‘half blind dovetail joints’.) For example, Australian patent application number 731,117 by Roger Gifkins (accepted advertised on 22 Mar. 2001) discloses a jig with templates which are followed by a router.

Similarly, U.S. Pat. No. 4,738,574 (to Robert Emmert) and U.S. Pat. No. 3,834,435 (to Wilfred M. McCord, Jr.) use templates in conjunction with a router for cutting timber for dovetail joints.

The apparatus disclosed in U.S. Pat. Nos. 4,531,559 and 4,632,159 (to Marion L. Glasgo) can be used with a hand-saw to cut dovetail joints. The Glasgo patents disclose a saw guide and marking template for marking and cutting pin and tail face cuts required in making dovetail joints. A central template having end faces that provide angled saw guides is clamped to the edge of the board to be worked. The angled saw guides can be repositioned by either rotating them about the end of a central template by inverting the entire device. The apparatus of Australian patent 734308 (to William Charles Chadwick) is similar to the apparatus of the Glasgo patents in that it discloses a saw guide for making cuts in one direction for a dovetail joint, which apparatus can be inverted to make cuts in a second direction. However, both the Glasgo and Chadwick patents require some degree of disassembly/reassembly to make the full range of cuts required. They also have restrictions on the range of angles of cuts that any particular implementation of the invention can achieve.

U.S. Pat. No. 5,575,191 (to Mary Wang) and U.S. Pat. No. 5,713,258 (to David P. Keddie) disclose mitre boxes in which the orientation of a saw guide, and so of the saw blade, can be adjusted about both vertical and horizontal axes. The apparatus of these patents will allow (for example) the making of the cuts that are necessary to produce the tenons of a dovetail joint by re-orienting (reversing) the workpiece. However, the making of the cuts necessary to produce the mortices for the dovetail joint requires the adjustment of the saw guide to specific angles.

Saw guides, or milling instruments, for orthopaedic surgery are also known. For example, U.S. Pat. No. 5,817,097 to Michael J. Howard et al. discloses a guide for a surgical saw blade or milling instrument. Howard et al. discloses a guide body with a guide surface at a fixed orientation to the bone to be cut in shaping the femur during prosthetic knee implantation surgery. U.S. Pat. No. 5,364,401 to Joseph M. Ferrante et al. similarly discloses apparatus for preparing a bone to receive a prosthetic implant. Like Howard et al., it provides saw guides which allow cutting in a limited number of directions relative to the bone.

### SUMMARY OF THE INVENTION

According to a first aspect, the present invention provides a cutting guide for orientating a saw blade into selectable ones of at least two positions, said saw blade cutting in a plane, which cutting guide includes:

means for orientating the plane of the saw blade into any one of a plurality of angular orientations relative to a first axis; and

rotation means whereby the means for orientating of the plane of the saw blade can be rotated about the first axis through an arc of at least 270°.

According to a second aspect, the present invention provides a surgical cutting guide for use with a surgical instrument for orientating a saw blade into selectable ones of at least two positions, the saw blade cutting in a plane, which surgical cutting guide includes:

means for orientating the plane of the saw blade into any one of a plurality of angular orientations relative to a first axis; and

rotation means whereby the means for orientating of the plane of the saw blade can be rotated about the first axis through an arc of at least 270°.

In contrast to the prior art, various embodiments of the present invention require less adjustment to produce all the tenons and mortices for a dovetail joint.

Some of the embodiments of the present invention can be used for cutting several types of woodworking joints, other than dovetail joints.

The present invention also avoids the need to use a router or other power driven cutter, to cut such joints.

Various embodiments of the present invention are adapted to use in orthopaedic surgery in a way that allows substantial adjustment of the angular range of cuts.

### PREFERRED EMBODIMENT OF THE INVENTION

In the case of the first aspect of the invention, it is preferred that the cutting guide further includes mounting means for mounting the rotation means, directly or indirectly, to a workpiece.

It is preferred that the means for orientating the plane of the saw blade includes means for rotation of the plane of the saw blade relative to a second axis which is perpendicular to the first axis.

It is preferred that the means for orientating the plane of the saw blade further includes means for rotation of the plane of the saw blade relative to a third axis, wherein the first, second and third axes are orthogonal.

It is preferred that the cutting guide further includes rotation means whereby the first axis can be rotated about a fourth axis which is parallel to one of the second and third axes.

It is preferred that the means for orientating the plane of the saw blade includes a guide for receipt of the saw blade.

It is preferred that the guide for receipt of the saw blade includes two opposed guide plates for receipt of the saw blade between them. Alternatively, it is preferred that the guide for receipt of the saw blade includes a magnet to attract the saw blade.

It is preferred that the rotation means includes a first shaft the axis of which is substantially coincident with the first axis; and at least part of the guide for receipt of the saw blade is pivotally mounted, directly or indirectly, to that shaft.

It is preferred that the rotation means includes a second shaft the axis of which is substantially coincident with the first axis; and

at least part of the guide for receipt of the saw blade is pivotally mounted at an end of that shaft.

It is preferred that the part of the guide that is pivotally mounted at an end of a shaft is a guide plate.

It is preferred that the pivotal mounting of each guide plate to a shaft creates the pivoting axis of the guide plate substantially at a face of the guide plate which is remote from the shaft.

It is preferred that the pivotal mounting includes a hinge leaf at an end of the shaft, which hinge leaf includes:

two opposite planar sides extending in the direction of the axis of the shaft;

a bore extending diametrically through the hinge leaf from one planar side to the opposite planar side; and

a substantially semi-cylindrical surface extending between the opposite planar sides, the centre-line of the semi-cylindrical surface being substantially coincident with the centre-line of the bore, and

two opposed flanges extending from the guide plate for receipt of the opposite planar sides of the hinge leaf between them, each flange including an arcuate aperture for receipt of a pin which passes through the bore in the hinge leaf.

It is preferred that the hinge leaf is readily detachable from the shaft.

It is preferred that the means for mounting the cutting guide to the work-piece includes two legs for receipt of the work-piece between them.

It is preferred that at least one of the legs includes threaded bores through it which extend substantially in the direction of the other leg.

It is preferred that at least one of the first and second shafts is rotationally mounted on the mounting means.

It is preferred that:

at least one of the first and second shafts that is rotationally mounted to the mounting means includes at least one circumferentially extending groove extending around the circumference of the shaft; and

the mounting means includes a pin for receipt in the groove.

It is preferred that at least one longitudinally extending groove extends along at least a portion of the shaft, which longitudinally extending groove:

intersects at least one of the circumferentially extending grooves; and

is adapted for receipt of the pin.

In the case of the second aspect of the invention, it is preferred that surgical cutting guide further includes mounting means for mounting the rotation means, directly or indirectly, to a bone.

It is preferred that the means for orientating the plane of the saw blade includes means for rotation of the plane of the saw blade relative to a second axis which is perpendicular to the first axis.

It is preferred that the means for orientating the plane of the saw blade further includes means for rotation of the plane of the saw blade relative to a third axis, wherein the first, second and third axes are orthogonal.

It is preferred that the surgical cutting guide further includes means whereby the first axis can be rotated about a fourth axis which is parallel to one of the second and third axes.

It is preferred that the means for orientating the plane of the saw blade includes a guide for receipt of the saw blade.

It is preferred that the guide for receipt of the saw blade includes a magnet to attract the saw blade.

It is preferred that:

the rotation means includes a first shaft the axis of which is substantially coincident with the first axis of rotation; and

at least part of the guide for receipt of the saw blade is pivotally mounted, directly or indirectly, to the shaft.

It is preferred that the part of the guide that is pivotally mounted, directly or indirectly to that shaft is a guide plate.

It is preferred that the pivotal mounting of the guide plate to the shaft creates the pivoting axis of the guide plate substantially at a face of the guide plate which is remote from the shaft.

It is preferred that the pivotal mounting includes:

a hinge leaf at an end of the shaft, which hinge leaf includes:

two opposite planar sides extending in the direction of the axis of the shaft;

a bore extending diametrically through the hinge leaf from one planar side to the opposite planar side; and

a substantially semi-cylindrical surface extending between the opposite planar sides, the centre-line-of the semi cylindrical surface being substantially coincident with the centre-line of the bore, and

two opposed flanges extending from the guide plate for receipt of the opposite planar sides of the hinge leaf between them, each flange including an arcuate aperture for receipt of a pin which passes through the bore in the hinge leaf.

It is preferred that the hinge leaf is readily detachable from the shaft.

It is preferred that the bone is the distal region of the femur.

It is preferred that the shaft is rotationally mounted on the mounting means.

It is preferred that:

the shaft that is rotationally mounted to the mounting means includes a at least one circumferentially extending groove extending around the circumference of the shaft; and

the mounting means includes a pin for receipt in the groove.

It is preferred that the surgical cutting guide further includes at least one longitudinally extending groove extending along at least a portion of the shaft, which longitudinally extending groove:

intersects at least one of the circumferentially extending grooves; and

is adapted for receipt of the pin.

### BRIEF DESCRIPTION OF THE FIGURES OF THE DRAWINGS

In order that the invention may be more readily understood, preferred embodiments are described below in conjunction with the drawings, in which:

FIG. 1 is a perspective view of a dovetail joint which can be produced with the aid of the present invention;

FIG. 2 is a perspective view of a finger joint which can be produced with the aid of the present invention;

FIG. 3 is a plan view of a comb joint which can be produced with the aid of the present invention;

FIG. 4 is a perspective view of a mitre joint which can be produced with the aid of the present invention;

FIG. 5 is a perspective view of one type of butterfly joint that can be produced with the aid of the present invention;

FIG. 6 is a perspective view of another type of butterfly joint that can be produced with the aid of the present invention;

FIG. 7 is a front elevational view of a first embodiment of the present invention;

FIG. 8 is one end elevational view of the embodiment of FIG. 5;

FIG. 9 is another end elevational view of the embodiment of FIG. 5;

FIG. 10 is a plan view of the embodiment of FIG. 5;

FIG. 11A is a perspective view of one component of the embodiment of FIG. 5,

FIG. 11B is an exploded perspective view of a sub-assembly of the embodiment of FIG. 5;

FIG. 12 is a front elevational view of a second embodiment of the present invention;

FIG. 13 is an end elevational view of the embodiment of FIG. 12;

FIG. 14 is a plan view of the embodiment of FIG. 12;

FIG. 15 is a perspective view, partly exploded, of the embodiment of FIG. 12;

FIG. 16 is a side elevational view of a third embodiment of the invention when in use in the course of orthopaedic surgery;

FIG. 17 is a plan view of a component of the embodiment of FIG. 16;

FIG. 18 is a front elevational view of the component of FIG. 17;

FIG. 19 is an elevational view of a component of an alternative embodiment of the equipment of FIG. 16;

FIG. 20 is a side elevational view of a component which is used with the component that is shown in FIG. 19

FIG. 21 is a front elevational view of the component of FIG. 19 in conjunction with the component of FIG. 20 and

FIG. 22 is a side elevational view of the components of FIG. 21.

### DESCRIPTION OF PREFERRED EMBODIMENTS OF THE INVENTION

Uses of the Cutting Guide

FIG. 1 generally indicates a dovetail joint by reference numeral 1 which joins two pieces of timber 2 and 3. The dovetail joint 1 is formed by the a plurality of partly wedge-shaped tenons 4 in the piece of timber 2 which inter-fit with a plurality of complementary mortices 6 in the timber 3 to form a right-angle joint between the two pieces of timber.

The accurate cutting of tenons and mortices by hand to form such a dovetail joint requires a relatively high degree of skill, and is time consuming even when performed by a skilled operator.

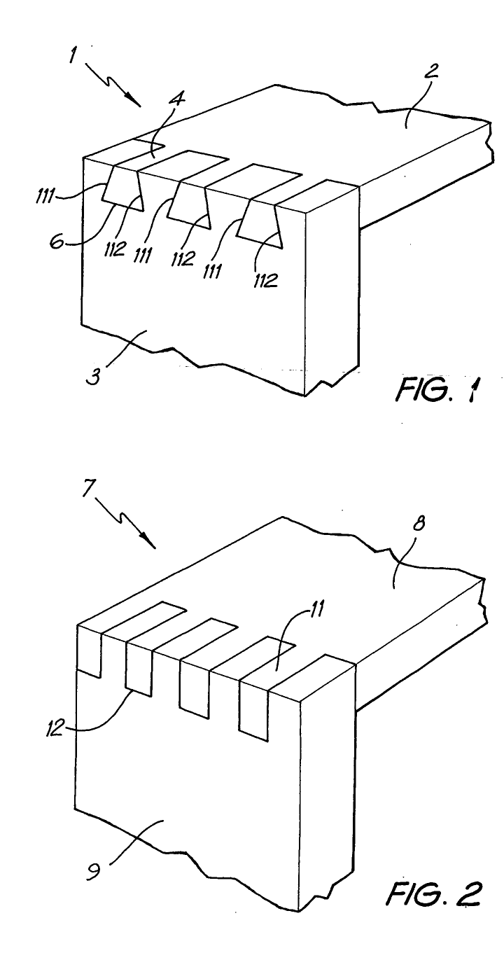

The operation of the preferred embodiments of the present invention are described with particular reference to the example of the dovetail joint of FIG. 1, although it will be clear that the present invention can also be used to produce the joints of FIGS. 2 to 6, in addition to other joints which are not illustrated in the drawings but which will be readily apparent to a person who is skilled in the art.

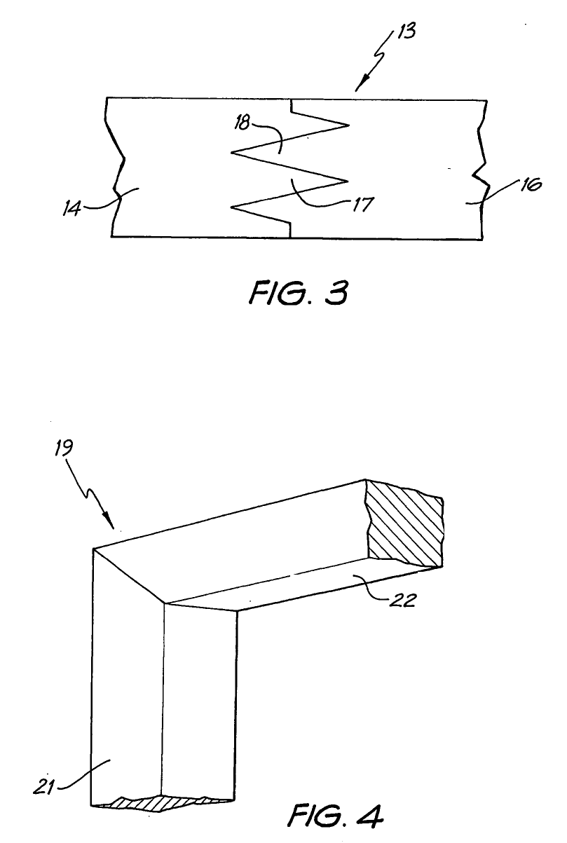

FIG. 2 shows a finger joint 7 between two pieces of timber 8 and 9 in which the tenons 11 in one piece of timber and the mortices 12 in the other piece of timber are both parallel sided, to form a right-angle joint between the two pieces of timber. FIG. 3 shows a comb joint 13 between two pieces of timber 14 and 16, in which the mortices 17 and the tenons 18 are indistinguishable from each other and are generally wedge shaped. The mortices and tenons interfit to form a planar joint between the two pieces of timber 14 and 16. FIG. 4 shows a mitre joint 19 between two pieces of timber 21 and 22 in which the abutting ends of the pieces of timber 14 and 16 are shaped at 45°. The ends of the two pieces of timber butt together to form a right angle joint.

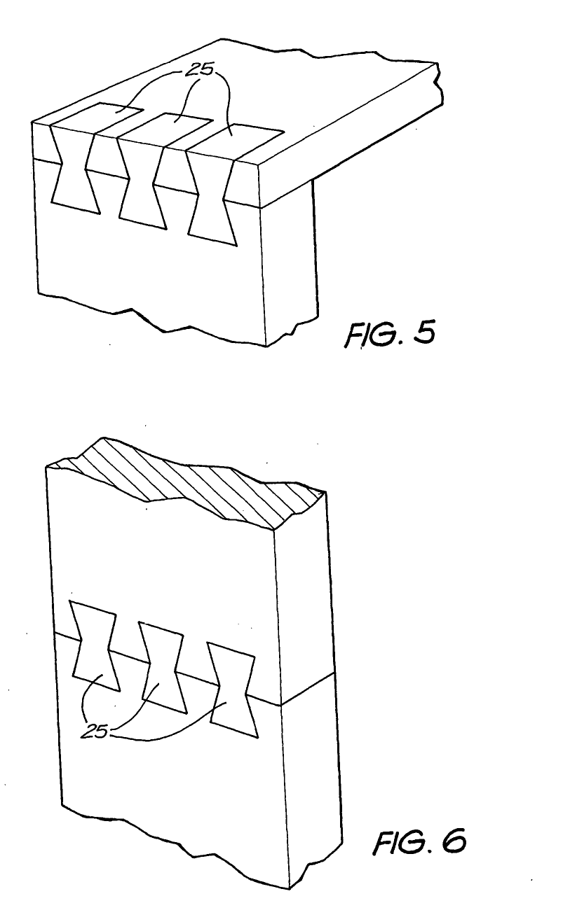

FIGS. 5 and 6 show two types of butterfly joints. The saw cuts in the pieces of timber that are to be joined to form such joints are the same as the cuts that must be made to the piece of timber 3 of FIG. 1 to form one half of a dovetail joint. However, instead of directly joining the pieces of timber by inter-fitting them, the pieces of timber are butted against each other along a join line and then joined by the placement of timber keys 25 as shown.

Construction of the Cutting Guide According to a First Embodiment of the Invention

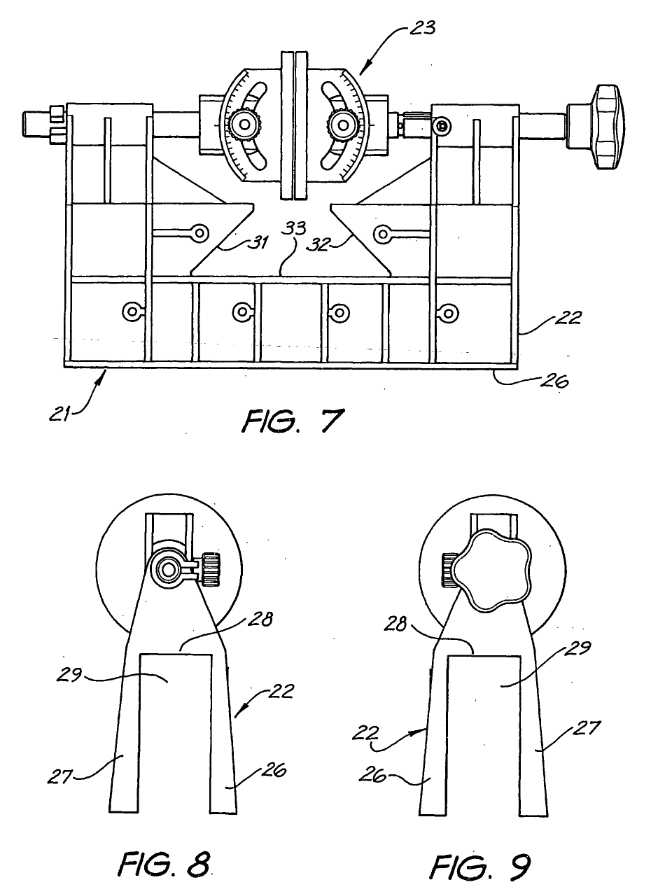

A cutting guide 21 is shown in front elevation in FIG. 7. The cutting guide 21 includes a base 22 and a generally transversally translatable and rotatable sub-assembly which is indicated generally at 23. It is preferred that the base 22 is fabricated by diecasting in an aluminum alloy.

The base 22 includes two generally opposed legs 26 and 27. The opposed legs 26 and 27 are bridged by a bridge 28. The adjacent surfaces of the opposed legs 26 and 27 and the adjacent surface of the bridge 28 are generally planar. Together they form a region which is indicated at 29 for the receipt of a piece of plane-sided timber.

The leg 26 (but not the leg 27) includes a number of screw-threaded holes 30 extending through the material of that leg portion.

The base 22 includes a centrally placed, generally truncated-wedge shaped aperture which is defined by the edges 31, 32 and 33. When a piece of timber (which is not illustrated in the drawings) is received in the region 29 of the base, an upper planar edge of the timber abuts against the lower surface of the bridge 28, and that upper edge and the adjacent side faces are exposed for working within this aperture.

The sub-assembly 23 includes two shafts 51 and 52, each of which is mounted in one of the two axially aligned journal bearings 41 and 42 which in turn are mounted on the bridge 28 of the base 22, at opposite ends of that base.

Each of the adjacent ends of the shafts 51 and 52 carries hinge leaf 53 and 54 respectively. The hinge leaf 53 has two opposite, planar sides 56 and 57, and an end face 58. The end face 58 is arcuate in the shape of a segment of a circle in a section in a vertical plane of the drawings and is straight in horizontal section. That is, the end face 58 is in the form of a portion of the curved surface of a cylinder.

Similarly the hinge leaf 54 has two opposite, planar sides 61 and 62, and an end face 63 which are of the same shapes as are the faces 56, 57 and 58 respectively.

The hinge leaf 53 has a bore 59 extending through it between the planar sides 56 and 57, and the hinge leaf 54 has a bore 60 extending through it between the planar sides 61 and 62.

The shaft 51 carries one longitudinally extending groove 94 and three circumferentially extending grooves 95, 96 and 97. The groove 95 is contiguous with one end of the longitudinally extending groove 94. The groove 96 bisects the longitudinally extending groove 94. The groove 97 is contiguous with the other end of the longitudinally extending groove 94.

A saw-guide plate 71 is pivotally mounted to the hinge leaf 53. The guide plate 71 includes a face plate 73 for abutment against a saw blade as described in detail below.

The guide plate 71 also includes two substantially parallel flanges 81 and 82 extending from it. The flange 81 includes an arcuate aperture 76 and the flange 82 similarly includes an arcuate aperture (which is not illustrated in the drawings). The flanges 81 and 82 have planar opposed surfaces 83 and 84 respectively.

The pivotal mounting of the guide plate 71 to the hinge leaf 53 is by way of a screw-threaded pin (not illustrated) which passes through the arcuate aperture in flange 82, through the bore 59 in hinge leaf 53, and through the arcuate aperture 76 in flange 81. The head end of the screw-threaded pin bears against the shoulders of the aperture in the flange 84, and the other end of the pin carries a knurled knob 78 which is threaded onto the pin. The semi-cylindrical surface 58 of the hinge leaf 56 bears against a rear surface (not illustrated) of the face plate 73.

With this form of pivotal mounting, the actual pivot axis of the face plate 71 is at, or very close to, a diameter of the circular surface of the exposed surface 73 of the face plate.

A spring-loaded pin (which is not illustrated) is captured in a radially extending bore 91 in the journal bearing 41. The end of this spring-loaded pin which is within the journal bearing 41 locates in the grooves 94, 95, 96 and 97.

Each of the circumferentially extending grooves 95, 96 and 97 includes four recessed detents 92. The end of the spring-loaded pin which is within the journal bearing 41 can locate in each of these detents to give a positive positioning of the shaft 51 at each of four rotational positions at each of three longitudinal positions of the shaft.

A saw guide plate 72 is also pivotally mounted to the hinge leaf 54 which in turn is mounted on the shaft 52. However shaft 52, unlike the shaft 51, is unconstrained in its longitudinal and rotational positioning within the journal bearing 42. A clamp 101 is mounted at an outer end of the journal bearing 42. A threaded screw and nut are carried in this clamp to clamp the shaft 52, and consequently the saw guide plate 72, at a desired longitudinal and rotational positioning.

The guide plate 72 includes a face plate 74 for abutment against a saw blade (which is not illustrated in the drawings) opposite the face plate 73. Preferred materials for the fabrication of the face plates 73 and 74 are any suitable metallic, ceramic or plastics material.

Operation of the Cutting Guide of the First Embodiment

According to the present embodiment of the invention, the saw cuts in the timber for the dovetail joints are cut by the use of a hand saw, the blade of which is held between the saw guide plates 71 and 72.

For example, the work-piece (which is not illustrated in the drawings) is held firmly in a generally vertical position by retention in a vice or the like which is also not illustrated.

To produce the dovetail joint 1 of FIG. 1, the base 22 of the cutting guide is placed over the end of the piece of timber 3 that is uppermost in FIG. 1, and securely clamped in place by use of screws (not illustrated) that pass through the screw-threaded bores 30 in the base 22 and bear against a face of the work-piece. These screws force the work-piece 3 firmly against the planar interior surface of the leg 27.

It would be usual to mark-out on the work-piece 3 the positioning of the saw cuts and chisel cuts which are necessary to cut the mortices into it.

In cases where it is necessary to give more rigidity to the fixing of the work-piece 3, a generally U-shaped clamp may be clamped to the work-piece below the base 22 and in supporting contact with the feet of the legs 26 and 27.

The angular orientation of the saw guide-plate 71 on the shaft 51 which is necessary to make the mortice cuts such as 111 in FIG. 1 is set, and clamped in place by use of the knob 78. A saw blade (which is not illustrated) is then inserted between the saw guide plates 71 and 72, and the guide plate 72 is firmly abutted against the saw blade. (The placement of the pivot axes of the face plates 73 and 74 which is described above results in little, if any, relative vertical movement of the uppermost and lowermost edges of the face plates 73 and 74 as they are pivoted to the correct angle to receive the saw. This absence of any substantial relative movement ensures that the saw blade is not left unsupported on one side below the face plates.) The clamp 101 is then tightened to keep shaft 52 and the guide plate 72 fixed in place, and the first saw cut is made in accordance with the markings on the work-piece.

When the first saw-cut is completed, the clamping of the cutting guide 21 to the work-piece 3 is loosened, and the cutting guide moved along the work-piece to where the saw-blade is correctly placed to make the next mortice cut 111. The cutting guide 21 is then again securely clamped to the work-piece 3 by means of the screws passing through the screw-threaded holes 30, and the next cut is made.

It will be appreciated that, to orient the saw guide plates 71 and 72 to make the next set of mortice cuts 112, it is only necessary to rotate the shaft 51 about its axis by 180° (without making any change to the pivot angle of the guide plate 71 on the shaft 51).

To make the tenon cuts, the piece of timber 3 is removed from the cutting guide and the piece of timber 2 is substituted. The pivot angle of the guide plate 71 on the shaft 51 is not changed. However, the shaft 51 is rotated through 90°, and the first set of tenon cuts is made with the shaft In this orientation. When the first set of tenon cuts is complete, the shaft 51 is rotated through 180°, and the second set of tenon cuts is made.

Once these saw cuts have been made, the residual timber is removed by chiseling in the known manner to complete the mortices and tenons for the joint.

It will also be appreciated that the comb joint of FIG. 3 and the butterfly joints of FIGS. 5 and 6 are produced in a similar manner, in that the only adjustments necessary to the cutting guide 21 to make the required saw cuts is rotation of the shaft 51.

It will usually be the case that, when making the saw cuts for the joints which are described above, the shaft 51 will be located in a central position in which the spring-loaded pin which passes through the bore 91 is located in the circumferential groove 96 of the shaft.

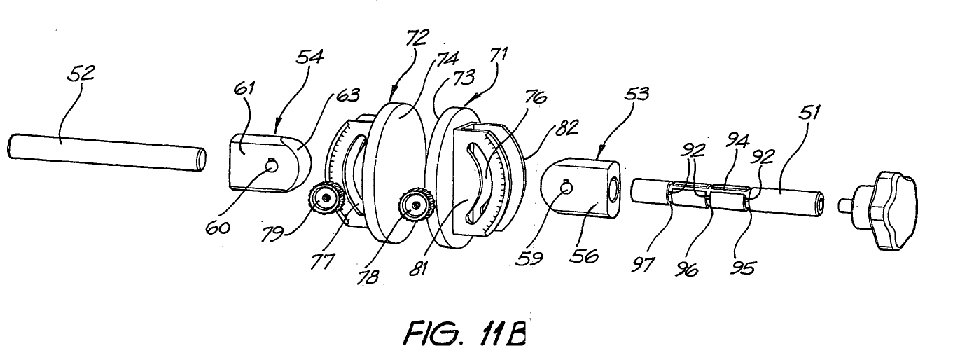

The circumferential grooves 95 and 97 in the shaft 51 are for use when cutting mitre joints. A mitre joint requires that relatively deep cuts be made at an angle of 45° to the centre line of each piece of timber that is being joined. For example, to make a saw cut that is in a direction of 45° downward to the right in FIG. 11A, and depending on the width of the material that is to be cut, it may be necessary to first move the shaft to the left so that the spring-loaded pin (not illustrated) that is in the bore 91 is aligned with the circumferential groove 97 in the shaft 51.

Construction of the Cutting Guide According to a Second Embodiment

A cutting guide 221 according to a second embodiment of the invention is shown in front elevation in FIG. 12. The cutting guide 221 includes a base 222 and a generally transversally translatable and rotatable sub-assembly which is indicated generally at 223. It is preferred that the base 222 is fabricated by diecasting in an aluminum alloy.

The base 222 includes two generally opposed legs 226 and 227. The opposed legs 226 and 227 are bridged by a bridge 228. The adjacent surfaces of the opposed legs 226 and 227 and the adjacent surface of the bridge 228 are generally planar. Together they form a region which is indicated at 229 for the receipt of a piece of plane-sided timber.

The leg 226 (but not the leg 227) includes a number of screw-threaded holes 30 extending through the material of that leg portion for the receipt of correspondingly screw-threaded clamping elements such as 225.

The base 222 includes end portions 231 and 232 defined by the edges of the legs 226 and 227 and the bridge 228. When a piece of timber (which is not illustrated in the drawings) is received in the region 229 of the base, an upper planar edge of the timber abuts against the lower surface of the bridge 228, and that upper edge and the adjacent side faces are exposed for working at either or both of end portions 231 and 232.

The sub-assembly 223 includes a shaft 251 which is mounted in a journal bearing 241. The journal bearing 241 is in turn carried by a turntable 242 which is rotatably mounted to the bridge 228 for rotation about an axis which will be substantially vertical when the cutting guide is in use. A set-screw 316 passes through an internally screw threaded hole 317 in the turntable 242. The leading end of the set screw (which is not illustrated in the drawings) can bear against an upper surface (not illustrated) of the bridge portion 228 to fix the turntable in a desired position. According to an alternative embodiment of the invention which is not illustrated in the drawings, instead of the turntable 242 being mounted to the bridge by a turntable, the journal bearing 241 is instead detachably mountable to the bridge 228 at any one of four orientations about the vertical axis.

One end of the shaft 251 carries a universal joint which includes hinge leafs 253 and 254. The hinge leaf 253 is fixed to an end of the shaft 251 remote from the turntable 242. The hinge leaf 253 has two internally opposite, planar surfaces 256 and 257. A bore 259 passes through the hinge leaf 253

An end of leaf hinge 254 carries opposed planar surfaces 260 and a bore 261 passes through the leaf between those surfaces 260. An opposite end of leaf hinge 254 carries opposed planar surfaces 263 which are displaced around a central axis of the leaf hinge 254 at 900 relative to the planar surfaces 260. The hinge leaf 254 also carries an end face 258. The end face 258 is arcuate in the shape of a segment of a circle in a the plane of the planar surfaces 263 and which is straight in the direction extending between the planar surfaces 263. That is, the end face 258 is in the form of a portion of the curved surface of a cylinder. A bore 262 passes through the leaf 254 between the opposite planar surfaces 263.

The shaft 251 carries one longitudinally extending groove (which is not shown in the drawings) and three circumferentially extending grooves 295, 296 and 297. The groove 295 is contiguous with one end of the longitudinally extending groove. The groove 296 bisects the longitudinally extending groove.

The groove 297 is contiguous with the other end of the longitudinally extending groove.

A saw-guide plate 271 is pivotally mounted to the hinge leaf 254. The guide plate 271 includes a face plate 273 for abutment against a saw blade as described in detail below.

The guide plate 271 also includes two substantially parallel flanges 281 and 282 extending from it. The flange 281 includes an arcuate aperture 276 and the flange 282 similarly includes an arcuate aperture 277. The flanges 281 and 282 have planar opposed surfaces 283 and 284 respectively.

The pivotal mounting of the guide plate 271 to the hinge leaf 254 is by way of a screw-threaded pin 301 which passes through the arcuate aperture 276 in the flange 281, through the bore 260 in hinge leaf 254, and through the arcuate aperture 277 in flange 282. The head end of the screw-threaded pin bears against the shoulders of the aperture in the flange 284, and the other end of the pin carries a knob 278 which is threaded onto the pin. The semi-cylindrical surface 258 of the hinge leaf 254 bears against a rear surface (not illustrated) of the guide plate 271. Similarly, the screw-threaded pin 302 and internally threaded knob 303 operate to pivotally connect the two hinge leafs 253 and 254.

Screw-threaded pins 306 and 307 are captured in radially extending bores 308 and 309 adjacent opposite ends of the journal bearing 41. The ends of these pins which are within the journal bearing 241 can be located in the grooves 295, 296 and 297, and in the longitudinally extending groove which is not illustrated.

Each of the circumferentially extending grooves 295, 296 and 297 includes four recessed detents 292. The ends of the screw-threaded pins which are within the journal bearing 241 can locate in each of these detents to give a positive positioning of the shaft 251 at each of four rotational positions at each of three longitudinal positions of the shaft.

The surface of the face plate 273 adjacent the body of the guide plate 271 includes a plurality of up-standing wells such as 311, projecting in the direction of the body of the guide plate 271. Each of the wells 311 is adapted to receive a magnet which is not shown in the drawings. Each magnet 311 can be any of a variety of suitable materials such as alnicos, ceramics and rare earths. In preferred embodiments the magnet is a rare earth such as samarium-cobalt and neodymium-iron-boron. The strength of the magnet must be large enough to attract a saw blade to the face plate while allowing movement of the saw blade in a cutting action.

Two resilient lugs 313 and 314 also project from the face plate in the direction of the body of the guide plate. The two resilient lugs 313 and 314 are each captured within corresponding apertures (which are not shown in the drawings) to detachably fix the face plate to the body of the guide plate.

Operation of the Cutting Guide of the Second Embodiment

According to the present embodiment of the invention, the saw cuts in the timber for the dovetail joints are cut by the use of a hand saw, the blade of which is held firmly against the face plate 273 by magnetic attraction.

As with the first embodiment of the invention, the work-piece (which is not illustrated in the drawings) is held firmly in a generally vertical position by retention in a vice or the like which also is not illustrated in the drawings.

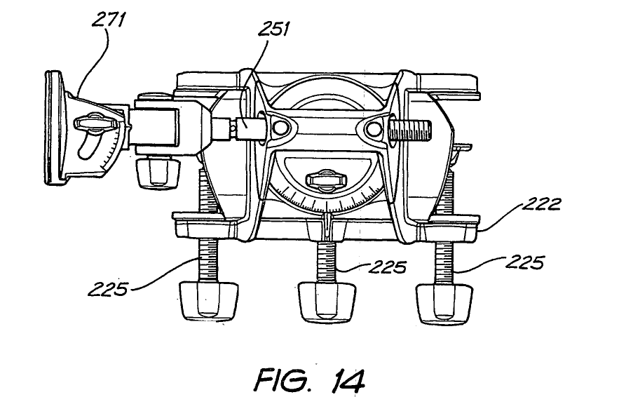

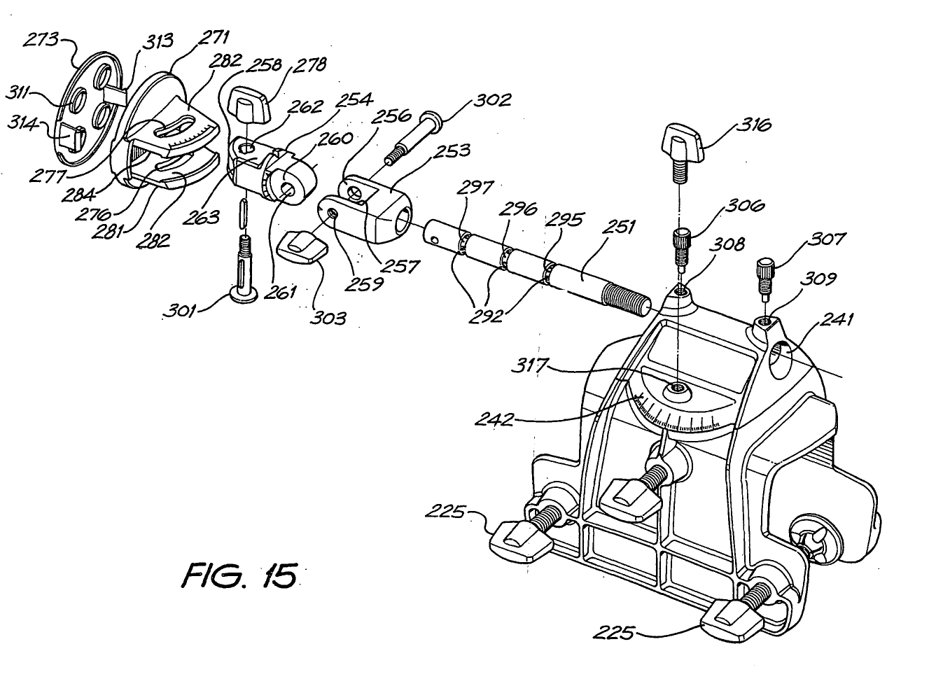

It will be appreciated that the shaft 251 may be inserted in the journal bearing 241 in the orientation shown in the drawings (that is, projecting in what is the left hand direction in FIGS. 12, 14 and 15) or in the opposite orientation (projecting in the right hand direction in those drawings).

It will also be appreciated that the apparatus of the second embodiment may, by suitable adjustment of its components, be used to make the cuts required for joints as described in conjunction with the description of the first embodiment of the invention. It will also be appreciated that the presence of the universal joint that is comprised of leaf elements 253 and 254 will allow the making of a range of cuts in the workpiece that are not possible with the first embodiment of the invention.

Construction of the Cutting Guide According to a Third Embodiment

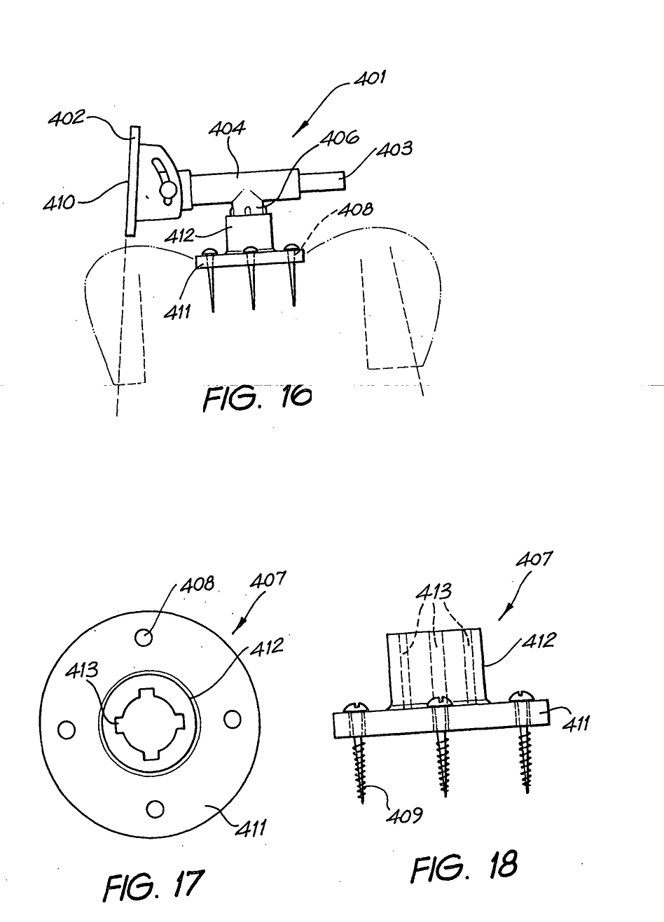

The embodiment of the cutting guide that is illustrated in FIGS. 16 to 22 is particularly adapted to use in the course of orthopaedic surgery.

The cutting guide 401 of FIG. 16 includes a saw guide 402. According to one especially preferred form of the invention which is not illustrated in the drawings, the saw guide 402 includes magnets within it to attract the blade of a surgical saw. The surface 410 of the saw guide 402 against which the blade of the saw bears is preferably of a wear-resistant material which does not diminish magnetic flux from the magnets. Suitable materials include stainless steels, coated stainless steels, and ceramics.

The saw guide 402 is pivotally mounted to a shaft 403, as is described above in respect of the construction of the first and second embodiments of the invention. The shaft 403 also carries a universal joint (which is not illustrated in the drawings).

The shaft 403 is rotatably mounted in journal bearings (not illustrated) within the housing 404. The housing 403 includes a mounting leg 406 which depends substantially vertically from the housing 403 in the orientation of the embodiment as shown in FIG. 16. According to this embodiment, the mounting leg 406 is substantially cylindrical in cross-section, and carries four longitudinally extending splines 405 which are placed around the outer circumference of the mounting leg 406 at spacings of 90° from each other.

The mounting leg 406 and is adapted for retention in a complementary mounting base 407 which is shown in greater detail in FIGS. 17 and 18. The mounting base 407 includes a mounting plate 411 which is generally circular in plan view and a socket 412 which is centrally placed in the mounting plate 411. The socket 412 is generally in the form of an open-topped cylinder and includes four internal keyways 413 for receipt of the splines 405 of the mounting leg 406. It will be understood that the mounting leg 406 may be placed into the mounting base 407 in any of four positions, each position displaced from the adjacent position by an angle of 90°. (According to an alternative preferred embodiment which is not illustrated in the drawings, the mounting leg 406 is rotatably mounted in journal bearings in the mounting base 407, allowing continuous adjustment of the position of the apparatus 401.)

The mounting plate 411 of the mounting base 407 is perforated with four holes 408. Each hole 408 is adjacent the periphery of the mounting plate 411. The holes are placed at relative spacings of 90° from each other. each hole 408 is adapted to receive a mounting screw such as 409.

Preferred materials for the shaft 403, housing 404, mounting leg 406, and mounting base 407 are stainless steel, titanium, and titanium alloys.

In the course of orthopaedic surgery for replacement of the knee joint with a prosthetic knee, the distal femoral condyles are first cut to provide a planar surface. This planar surface has the mechanical axis of the femur as a perpendicular to it. As illustrated in FIG. 16, the apparatus 401 is then attached to the distal end of the trimmed femur by bone connectors 409. According to the embodiment of the invention which is illustrated, the bone connectors 409 are screw-threaded stainless steel. According to other embodiments of the invention which are not illustrated, the bone connectors 409 are smooth pins of any suitable material.

As is understood in the art, the apparatus 401 is then adjusted so that the saw guide is suitably orientated to make other cuts to the distal end of the femur for receipt of the upper portion of the prosthetic knee joint.

According to the embodiment of the invention that is illustrated in FIGS. 16 to 18, the saw guide 402 includes suitable magnets for the attraction of the blade of a surgical saw to the guide.

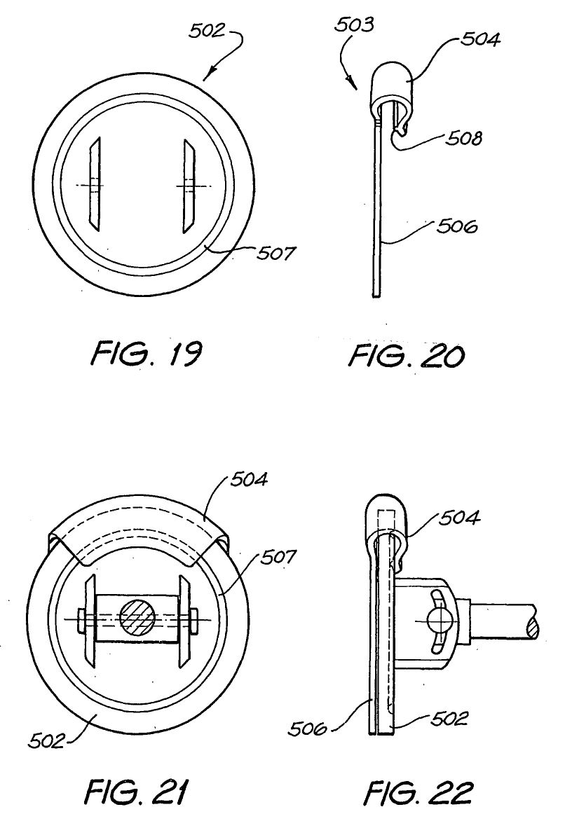

According to the embodiment which is illustrated in FIGS. 19 to 20, the saw guide 502 does not include any magnets to attract the blade of the surgical saw. Instead, a clip which is illustrated generally at 503 is attachable to the saw guide 502 to locate the saw blade between the clip 502 and a free end of the saw guide 502. The clip 503 includes a generally circular, planar body member 506 with a retaining member 504 contiguous with the body member 506 over an arc the circumference of the body member. The retaining member 504 is of resilient material so that the clip 502 can be retained on the saw guide 503 by gripping that saw guide between the body member 506 and the retaining member 504. It is preferred that a rear surface of the saw guide 502, remote from the body member 506, includes a substantially circular groove adjacent its periphery for receipt of an arcuate notch 508 in the retaining member 504.

According to other embodiments of the cutting guide for orthopaedic surgery (which are not illustrated in the drawings), a housing such as housing 404 is mounted in any suitable manner to a plate which is in turn suitably mounted on the femur and adjacent the distal end prior to the removal of the distal femoral condyles. This allows the use of the cutting guide in the removal of the distal femoral condyles, as well as in making other cuts in the course of trimming the femur for receipt of a prosthesis.

Alternative Constructions of the Cutting Guide

Although embodiments of the invention have been described above in which a hand-saw is guided between two saw guide-plates such as 71 and 72, or against a single saw guide such as 271 and 402, in alternative preferred embodiments of the invention which are not illustrated, a powered oscillating saw is mountable for pivotal movement of its blade in the manner which is described above.

According to yet further preferred embodiments of the invention, lateral indexing of the saw blade (that is, in the direction of the width of the work-piece) is automated.

It will be appreciated that the cutting guide 21 (or 221) is produced in a variety of sizes to suit a variety of spacings between the legs 26, and 27 (or 226 and 227) to accommodate a variety of depths of work-piece. However, because the cutting guide 21 (or 221) can be removed from the work-piece after making a series of saw cuts and then re-positioned on the work-piece to make another series of saw cuts, it is not necessary to produce the cutting guide in wide sizes to accommodate wide work-pieces.

It will be appreciated that variations, alterations and additions are possible within the scope of the present invention.

1. A cutting guide for orientating a saw blade into selectable ones of at least two positions, said saw blade cutting in a plane, which cutting guide includes:
means for orientating the plane of the saw blade into any one of a plurality of angular orientations relative to a first axis;
rotation means whereby the means for orientating of the plane of the saw blade can be rotated about the first axis through an arc of at least 270°.

2. A cutting guide as claimed in claim 1, further including mounting means for mounting the rotation means, directly or indirectly, to a workpiece

3. A cutting guide as claimed in claim 1 or claim 2, in which the means for orientating the plane of the saw blade includes means for rotation of the plane of the saw blade relative to a second axis which is perpendicular to the first axis.

4. A cutting guide as claimed in claim 3, in which the means for orientating the plane of the saw blade further includes means for rotation of the plane of the saw blade relative to a third axis, wherein the first, second and third axes are orthogonal.

5. A cutting guide as claimed in claim 4, further including rotation means whereby the first axis can be rotated about a fourth axis which is parallel to one of the second and third axes.

6. A cutting guide as claimed in any one of the preceding claims in which the means for orientating the plane of the saw blade includes a guide for receipt of the saw blade.

7. A cutting guide as claimed in claim 6, in which the guide for receipt of the saw blade includes two opposed guide plates for receipt of the saw blade between them.

8. A cutting guide as claimed in claim 6, in which the guide for receipt of the saw blade includes a magnet to attract the saw blade.

9. A cutting guide as claimed in claim 6, in which the guide for receipt of the saw blade includes a guide plate and a clip, adapted for the readily-detachable retention of the saw blade between the guide plate and the clip.

10. A cutting guide as claimed in claim any one of the preceding claims:
in which the rotation means includes a first shaft the axis of which is substantially coincident with the first axis; and
in which at least part of the guide for receipt of the saw blade is pivotally mounted, directly or indirectly, to that shaft.

11. A cutting guide as claimed in claim 10:
in which the rotation means includes a second shaft the axis of which is substantially coincident with the first axis; and
in which at least part of the guide for receipt of the saw blade is pivotally mounted at an end of that shaft.

12. A cutting guide as claimed in claim 10 or claim 11, in which the part of the guide that is pivotally mounted at an end of a shaft is a guide plate.

13. A cutting guide as claimed in claim 12, in which the pivotal mounting of each guide plate to a shaft creates the pivoting axis of the guide plate substantially at a face of the guide plate which is remote from the shaft.

14. A cutting guide as claimed in claim 13, in which the pivotal mounting includes:
a hinge leaf at an end of the shaft, which hinge leaf includes:
two opposite planar sides extending in the direction of the axis of the shaft;
a bore extending diametrically through the hinge leaf from one planar side to the opposite planar side; and
a substantially semi-cylindrical surface extending between the opposite planar sides, the centre-line of the semi-cylindrical surface being substantially coincident with the centre-line of the bore, and
two opposed flanges extending from the guide plate for receipt of the opposite planar sides of the hinge leaf between them, each flange including an arcuate aperture for receipt of a pin which passes through the bore in the hinge leaf.

15. A cutting guide as claimed in claim 14, in which the hinge leaf is readily detachable from the shaft.

16. A cutting guide as claimed in claim 15 in which the means for mounting the cutting guide to the work-piece includes two legs for receipt of the work-piece between them.

17. A cutting guide as claimed in claim 16, in which at least one of the legs includes threaded bores through it which extend substantially in the direction of the other leg.

18. A cutting guide as claimed in any one of claims 10 to 17, in which at least one of the first and second shafts is rotationally mounted on the mounting means.

19. A cutting guide as claimed in claim 18, in which:
at least one of the first and second shafts that is rotationally mounted to the mounting means includes at least one circumferentially extending groove extending around the circumference of the shaft; and
the mounting means includes a pin for receipt in the groove.

20. A cutting guide as claimed in claim 19, further including at least one longitudinally extending groove extending along at least a portion of the shaft, which longitudinally extending groove:
intersects at least one of the circumferentially extending grooves; and
is adapted for receipt of the pin.

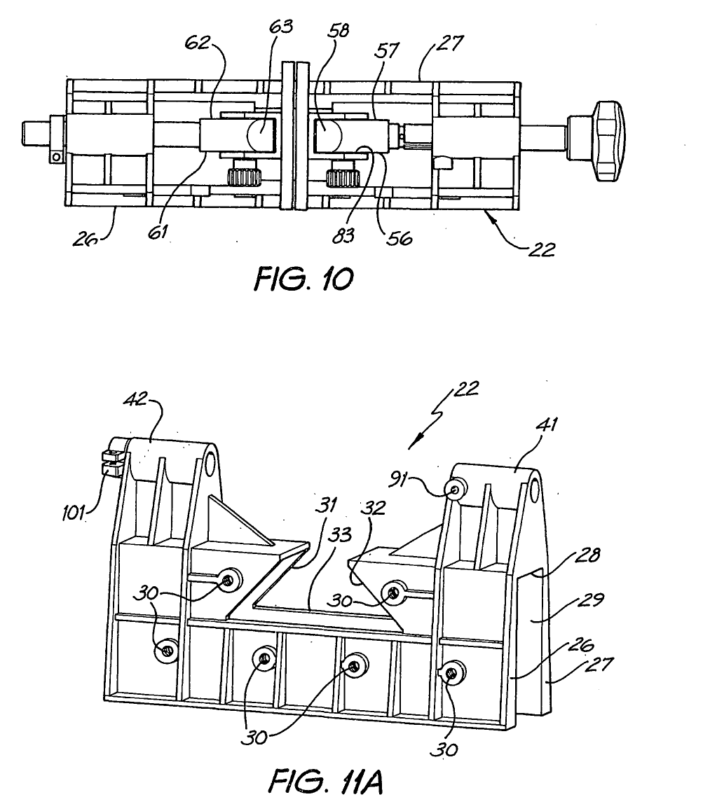

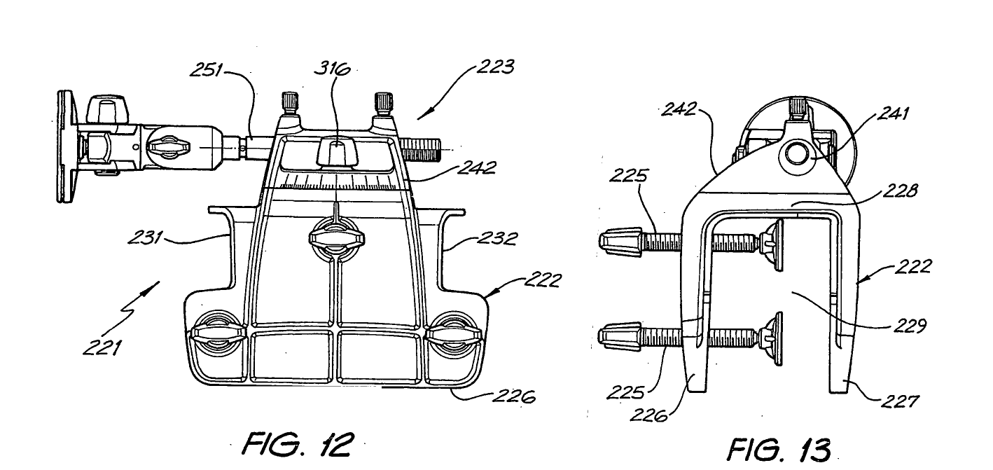

21. A cutting guide as claimed in any one of the preceding claims, substantially as described with reference to FIGS. 7 to 11B or FIGS. 12 to 15 of the drawings.

22. A cutting guide substantially as described with reference to FIGS. 7 to 111B or FIGS. 12 to 15 of the drawings.

23. A surgical cutting guide for use with a surgical instrument for orientating a saw blade into selectable ones of at least two positions, the saw blade cutting in a plane, which surgical cutting guide includes:
means for orientating the plane of the saw blade into any one of a plurality of angular orientations relative to a first axis;
rotation means whereby the means for orientating of the plane of the saw blade can be rotated about the first axis through an arc of at least 270°.

24. A surgical cutting guide as claimed in claim 23, further including mounting means for mounting the rotation means, directly or indirectly, to a bone.

25. A surgical cutting guide as claimed in claim 24, in which the means for orientating the plane of the saw blade includes means for rotation of the plane of the saw blade relative to a second axis which is perpendicular to the first axis.

26. A surgical cutting guide as claimed in claim 25, in which the means for orientating the plane of the saw blade further includes means for rotation of the plane of the saw blade relative to a third axis, wherein the first, second and third axes are orthogonal.

27. A surgical cutting guide as claimed in claim 26, further including means whereby the first axis can be rotated about a fourth axis which is parallel to one of the second and third axes.

28. A surgical cutting guide as claimed in any one of claims 23 to 27 in which the means for orientating the plane of the saw blade includes a guide for receipt of the saw blade.

29. A surgical cutting guide as claimed in claim 28, in which the guide for receipt of the saw blade includes a magnet to attract the saw blade.

30. A surgical cutting guide as claimed in claim 27, in which the guide for receipt of the saw blade includes a guide plate and a clip, adapted for the readily-detachable retention of the saw blade between the guide plate and the clip.

31. A surgical cutting guide as claimed in any one of claims 23 to 30:
in which the rotation means includes a first shaft the axis of which is substantially coincident with the first axis of rotation; and
in which at least part of the guide for receipt of the saw blade is pivotally mounted, directly or indirectly, to the shaft.

32. A surgical cutting guide as claimed in claim 31, in which the part of the guide that is pivotally mounted, directly or indirectly to that shaft is a guide plate.

33. A surgical cutting guide as claimed in claim 32, in which the pivotal mounting of the guide plate to the shaft creates the pivoting axis of the guide plate substantially at a face of the guide plate which is remote from the shaft.

34. A surgical cutting guide as claimed in claim 33, in which the pivotal mounting includes:
a hinge leaf at an end of the shaft, which hinge leaf includes:
two opposite planar sides extending in the direction of the axis of the shaft;
a bore extending diametrically through the hinge leaf from one planar side to the opposite planar side; and
a substantially semi-cylindrical surface extending between the opposite planar sides, the centre-line of the semi-cylindrical surface being substantially coincident with the centre-line of the bore, and
two opposed flanges extending from the guide plate for receipt of the opposite planar sides of the hinge leaf between them, each flange including an arcuate aperture for receipt of a pin which passes through the bore in the hinge leaf.

35. A surgical cutting guide as claimed in claim 34, in which the hinge leaf is readily detachable from the shaft.

36. A surgical cutting guide as claimed in any one of claims 23 to 35, in which the bone is the distal region of the femur.

37. A surgical cutting guide as claimed in any one of claims 24 to 35, in which the bone is a region of the tibia.

38. A surgical cutting guide as claimed in any one of claims 23 to 37, in which the shaft is rotationally mounted on the mounting means.

39. A surgical cutting guide as claimed in claim 37 or claim 38, in which:
the shaft that is rotationally mounted to the mounting means includes at least one circumferentially extending groove extending around the circumference of the shaft; and
the mounting means includes a pin for receipt in the groove.

40. A surgical cutting guide as claimed in claim 39, further including at least one longitudinally extending groove extending along at least a portion of the shaft, which longitudinally extending groove:
intersects at least one of the circumferentially extending grooves; and is adapted for receipt of the pin.

41. A surgical cutting guide as claimed in any one claims 23 to 40, substantially as described with reference to FIGS. 16 to 18 of the drawings.

42. A surgical cutting guide substantially as claimed in any one claims 25 to 38, substantially as described with reference to FIGS. 16 to 22 of the drawings.
